(19) United States
(12) Patent Application Publication
(10) Pub. No.: US 2014/0358288 A1
(43) Pub. Date: Dec. 4, 2014

(54) FAN SPEED CONTROL SYSTEM, METHOD, AND COMPUTING DEVICE

(71) Applicant: HON HAI PRECISION INDUSTRY CO., LTD., New Taipei (TW)

(72) Inventor: YU-CHEN HUANG, New Taipei (TW)

(73) Assignee: HON HAI PRECISION INDUSTRY CO., LTD., New Taipei (TW)

(21) Appl. No.: 14/288,823

(22) Filed: May 28, 2014

(30) Foreign Application Priority Data
May 30, 2013 (TW) 102119092

(51) Int. Cl. G05B 15/02

(52) U.S. Cl. CPC G05B 15/02
USPC 700/275

(57) ABSTRACT

In a fan speed control method, when a current working mode of a CPU is a Turbo mode, a current temperature of the CPU is obtained for every predetermined time period. A slope of a curve formed by obtained temperatures and corresponding times of obtaining the temperatures is computed. Then, a speed of a fan is adjusted according to the slope of the curve and the current temperature of the CPU.

### FIELD

Embodiments of the present disclosure relate to hardware control for a computing device, and more specifically to a system and method of speed control of a fan in a computing device.

### BACKGROUND

Turbo Boost is a technology that enables a central processor unit (CPU) to run above its base operating frequency via dynamic control of the CPU's clock rate. The Turbo Boost is activated when an operating system requests the highest performance state of the CPU, thus the CPU may exceeds its thermal design power (TDP), or the maximum amount of heat generated by the CPU. Thus, removing excessive heat produced by the CPU is important to keep the CPU within permissible operating temperature limits.

### BRIEF DESCRIPTION OF THE DRAWINGS

FIG. 1 is a schematic block diagram of one example embodiment of a computing device that includes a fan speed control system.

FIG. 2 is a block diagram of one example embodiment of function modules of the fan speed control system in FIG. 1.

FIG. 3 is a flowchart of one example embodiment of a fan speed control method.

FIG. 4 illustrates an example of a curve formed by the temperatures and the corresponding times of obtaining the temperatures

### DETAILED DESCRIPTION

Embodiments of the disclosure are discussed below with reference to the figures. However, those skilled in the art will readily appreciate that the detailed description given herein with respect to these figures is for explanatory purposes as the disclosure extends beyond these limited embodiments. For example, it should be appreciated that those skilled in the art will, in light of the teachings of the present disclosure, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the disclosure that are too numerous to be listed but that all fit within the scope of the disclosure. Also, singular words should be read as plural and vice versa and masculine as feminine and vice versa, where appropriate, and alternative embodiments do not necessarily imply that the two are mutually exclusive.

In the following description and claims, the terms “module” may be used. the word “module,” refers to logic embodied in hardware or firmware, or to a collection of software instructions, written in a programming language, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device.

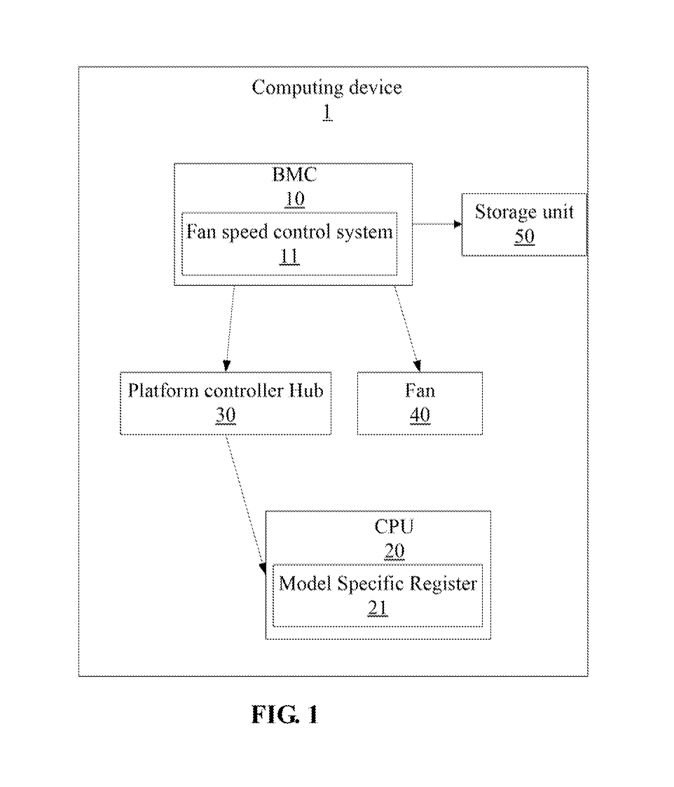

FIG. 1 is a schematic block diagram of one example embodiment of a computing device 1 that includes a fan speed control system 11. The computing device 1 may be a computer, a server, for example. The computing device 1 further includes a

Baseboard Management Controller (BMC) 10, a Center Processing Unit (CPU) 20, a Platform Controller Hub (PCH) 30, a fan 40, and a storage unit 50. The fan speed control system 11 is installed and running in the BMC 10.

The CPU 20 includes a Model Specific Register (MSR), which stores information of a current temperature of the CPU 20 and a current working mode of the CPU 20. In one embodiment, the working mode of the CPU 20 may include a safe mode and a Turbo mode, for example. It may be understood that, the Turbo mode is the CPU 20 running above its base operating frequency, namely, Turbo Boost, and the safe mode is the CPU 20 running below its base operating frequency.

The PCH 30 can obtain the temperatures of the CPU 20 and the current working mode of the CPU 20 from the MSR 21 of the CPU 20.

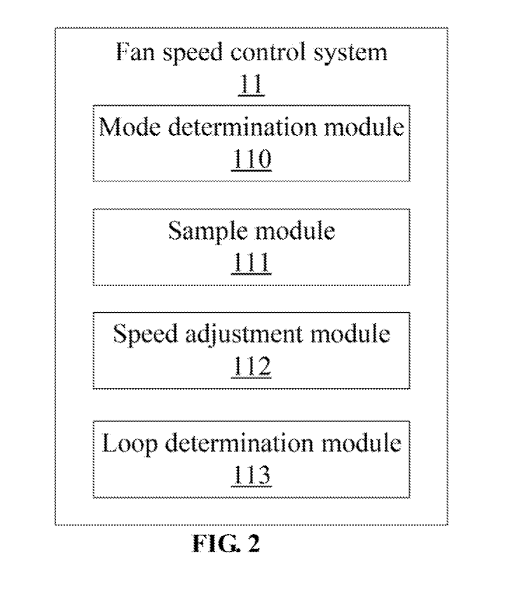

The fan speed control system 11 includes a plurality of function modules (shown in FIG. 2) that includes computerized codes stored in the storage unit 50, and can be executed by the BMC 10, to control a speed of the fan 40 according to the temperatures of the CPU 20 when the working mode of CPU 20 is the Turbo mode.

The storage unit 50 can include some type(s) of non-transitory computer-readable storage medium, for example a hard disk drive, a compact disc, a digital video disc, or a tape drive.

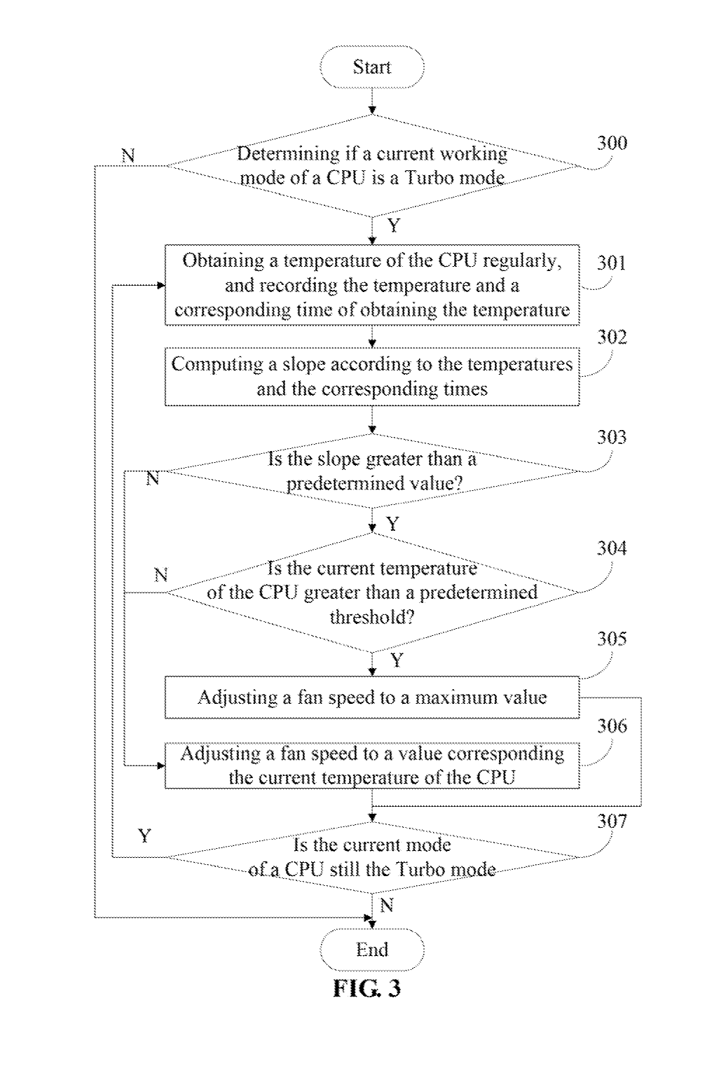

FIG. 2 is a block diagram of one example embodiment of function modules of the fan speed control system 11 in FIG. 1. The function modules can include a mode determination module 110, a sample module 111, a speed adjustment module 112, and a loop determination module 113. The function modules 110-113 can provide at least the functions needed to execute the steps illustrated in FIG. 3.

FIG. 3 is a flowchart of one example embodiment of a fan speed control method. In the embodiment, the method is performed by execution of computer-readable software program codes or instructions by at least one control device (i.e., BMC 10) of the computing device 1. Depending on the embodiment, additional steps in FIG. 3 can be added, removed, and the ordering of the steps may be changed.

In 300, the mode determination module 110 determines if the current working mode of the CPU 20 is the Turbo mode. As mentioned above, the current working mode of the CPU 20 can be obtained from the MSR 21 of the CPU 20 by the PCH 30. When the current working mode of the CPU 20 is the Turbo mode, the procedure executes the following 301. Otherwise, when the current working mode of the CPU 20 is not the Turbo mode, the procedure ends.

In 301, the sample module 111 obtains the current temperature of the CPU 20 for every predetermined time period, and records the obtained temperatures and corresponding times of obtaining the temperatures into, the storage unit 50, for example. As mentioned above, the temperatures of the CPU 20 can be obtained from the MSR 21 of the CPU 20 by the PCH 30. The predetermined time period of obtaining the temperature of the CPU 20 may be, 2 seconds, for example.

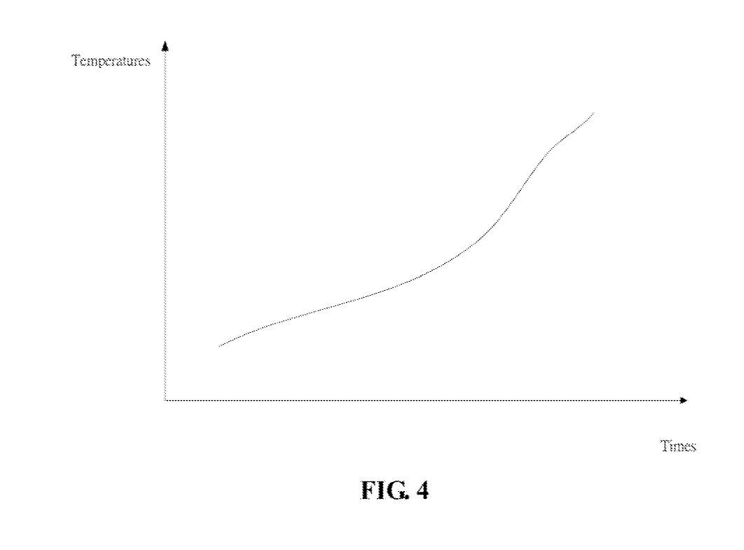

In 302, the sample module 111 computes a slope of a curve formed by the temperatures and the corresponding times of obtaining the temperatures. An example of the curve is illustrated in FIG. 4.

In 303, the speed adjustment module 112 determines if the slope of the curve is greater than a predetermined value, such as 0.8. When the slope of the curve is greater than the predetermined value, the procedure executes the following 304. When the slope of the curve is not greater than the predetermined value, the procedure executes the following 306.

In 304, the speed adjustment module 112 further determines if the current temperature of the CPU 20 is greater than a predetermined threshold. In one embodiment, the predetermined threshold can be equal to the maximum temperature of the CPU 20 subtracting an offset. When the current temperature of the CPU 20 is greater than the predetermined threshold, the procedure executes the following 305. When the current temperature of the CPU 20 is not greater than the predetermined threshold, the procedure executes the following 306.

In 305, the speed adjustment module 112 adjusts a speed of the fan 40 to a predetermined speed. In one embodiment, the predetermined speed can be the maximum speed of the fan 40.

In 306, the speed adjustment module 112 adjusts a speed of the fan 40 to a speed corresponding to the current temperature of the CPU 20. In one embodiment, a list which records a relationship between temperatures of the CPU 20 and the speeds of the fan 40 can be stored in the storage unit 50. Thus, the speed adjustment module 112 adjusts the speed of the fan 40 according to the list.

In 307, the loop determination module 113 determines if the current mode of the CPU 20 is still the Turbo mode. The procedure executes the above 301 when the current mode of the CPU 20 is still the Turbo mode. Otherwise, the procedure ends when the current mode of the CPU 20 is not the Turbo mode.

It should be emphasized that the above-described embodiments of the present disclosure, including any particular embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

What is claimed is:

1. A fan speed control method being executed by at least one control device of a computing device, the method comprising:
obtaining a current temperature of a center processing unit (CPU) for every predetermined time period and recording obtained temperatures and corresponding times of obtaining the temperatures, when a current working mode of the CPU is a Turbo mode;
computing a slope of a curve formed by the obtained temperatures and the corresponding times of obtaining the temperatures;
adjusting a speed of a fan of the computing device to a predetermined speed, when the slope of the curve is greater than a predetermined value and the current temperature of the CPU is greater than a predetermined threshold; and
adjusting the speed of the fan to a speed corresponding to the current temperature of the CPU, when the slope of the curve is not greater than the predetermined value, or when the slope of the curve is greater than the predetermined value and the current temperature of the CPU is not greater than the predetermined threshold.

2. The method according to claim 1, wherein the temperatures and the current working mode of the CPU are obtained from a Model Specific Register (MSR) of the CPU by a Platform Controller Hub (PCH).

3. The method according to claim 1, wherein the predetermined speed is the maximum speed of the fan.

4. The method according to claim 1, wherein the predetermined value is 0.8.

5. The method according to claim 1, wherein the predetermined threshold is equal to the maximum temperature of the CPU subtracting an offset.

6. The method according to claim 1, wherein the speed of the fan is adjusted to the speed corresponding to the current temperature of the CPU according to a list which records a relationship between temperatures of the CPU and the speeds of the fan.

7. The method according to claim 1, wherein the control device of the computing device is a baseboard management controller (BMC).

8. A computing device, comprising:
a center processing unit (CPU);
a fan;
a control device; and
a storage device storing one or more programs which when executed by the control device, causes the control device to:
obtain a current temperature of the CPU for every predetermined time period and recording obtained temperatures and corresponding times of obtaining the temperatures, when a current working mode of the CPU is a Turbo mode;
computing a slope of a curve formed by the obtained temperatures and the corresponding times of obtaining the temperatures;
adjusting a speed of the fan of the computing device to a predetermined speed, when the slope of the curve is greater than a predetermined value and the current temperature of the CPU is greater than a predetermined threshold; and
adjusting the speed of the fan to a speed corresponding to the current temperature of the CPU, when the slope of the curve is not greater than the predetermined value, or when the slope of the curve is greater than the predetermined value and the current temperature of the CPU is not greater than the predetermined threshold.

9. The computing device according to claim 8, wherein the CPU comprises a model specific register (MSR) which stores the temperatures and the current working mode of the CPU.

10. The computing device according to claim 8, further comprising a platform controller hub (PCH) that obtains the temperatures and the current working mode of the CPU from the MSR.

11. The computing device according to claim 8, wherein the predetermined speed is the maximum speed of the fan.

12. The computing device according to claim 8, wherein the predetermined value is 0.8.

13. The computing device according to claim 8, wherein the predetermined threshold is equal to the maximum temperature of the CPU subtracting an offset.

14. The computing device according to claim 8, wherein the speed of the fan is adjusted to the speed corresponding to the current temperature of the CPU is according to a list which records a relationship between temperatures of the CPU and the speeds of the fan.

15. The computing device according to claim 8, wherein the predetermined threshold is equal to the maximum temperature of the CPU subtracting an offset.

16. A non-transitory storage medium having stored thereon instructions that, when executed by a control device of a computing device, causes the control device to perform a fan speed control method, wherein the method comprises:
obtaining a current temperature of a center processing unit (CPU) for every predetermined time period and recording obtained temperatures and corresponding times of obtaining the temperatures, when a current working mode of the CPU is a Turbo mode;
computing a slope of a curve formed by the obtained temperatures and the corresponding times of obtaining the temperatures;
adjusting a speed of a fan of the computing device to a predetermined speed, when the slope of the curve is greater than a predetermined value and the current temperature of the CPU is greater than a predetermined threshold; and
adjusting the speed of the fan to a speed corresponding to the current temperature of the CPU, when the slope of the curve is not greater than the predetermined value, or when the slope of the curve is greater than the predetermined value and the current temperature of the CPU is not greater than the predetermined threshold.

17. The non-transitory storage medium according to claim 16, wherein the predetermined speed is the maximum speed of the fan.

18. The non-transitory storage medium according to claim 16, wherein the predetermined value is 0.8.

19. The non-transitory storage medium according to claim 16, wherein the predetermined threshold is equal to the maximum temperature of the CPU subtracting an offset.

20. The non-transitory storage medium according to claim 16, wherein the speed of the fan is adjusted to the speed corresponding to the current temperature of the CPU is according to a list which records a relationship between temperatures of the CPU and the speeds of the fan.
